(19) United States
(12) Patent Application Publication
(10) Pub. No.: US 2006/0117007 A1
(43) Pub. Date: Jun. 1, 2006

(54) Data processing apparatus

(76) Inventors: Masaharu Tsujimura, Toyonaka-shi (JP); Toshikazu Koudo, Nishinomiya-shi (JP); Kazuhiro Mihara, Moriguchi-shi (JP)

Correspondence Address: MARK D. SARALINO (MEI);RENNER, OTTO, BOISSELLE & SKLAR, LLP, 1621 EUCLID AVENUE, 19TH FLOOR, CLEVELAND, OH, 44115, US

(21) Appl. No.: 11/289,668

(22) Filed: Nov. 29, 2005

(30) Foreign Application Priority Data
Nov. 30, 2004 (JP) 2004-345359

(51) Int. Cl. G06F 17/30

(52) U.S. Cl. 707/6

(57) ABSTRACT

A data processing apparatus includes: a reception section for receiving a signal containing video information of a program and guide information to be utilized for guidance concerning the program, the guide information being distinct from viewing restriction information which is defined by a standard; a determination section for determining whether a predetermined pattern for viewing restriction is contained in the guide information or not; a management information generation section for determining whether or not to restrict viewing of the program based on a result of the determination, and generating management information in which presence or absence of viewing restriction is specified with respect to the program; and an output control section for controlling output of information concerning the program based on the management information.

### BACKGROUND OF THE INVENTION

1. Field of the Invention

The present invention relates to a technique for restricting viewing of a program. More specifically, the present invention relates to a technique for restricting the displaying, recording, playback, or the like to be performed of a program, and the management after a program whose viewing is restricted has been recorded.

2. Description of the Related Art

Techniques for restricting a user's viewing depending on the content of a broadcast program have conventionally been developed. In many countries, standards for multiplexing information indicating whether or not to restrict a user's viewing (viewing restriction information) onto a broadcast are designated. Each broadcasting entity is encouraged to perform broadcasting according to such standards.

Receivers and players are being produced so as to comply with such standards. For example, an apparatus disclosed in Japanese Laid-Open Patent Publication No. 2001-145033 switches its operation between outputting and not outputting a program, the switching being made in accordance with the content of viewing restriction information which is contained in the broadcast.

There have been increasing opportunities where a user is allowed to view a program without particular restrictions, even in the presence of standards concerning viewing restriction. The reason is that each broadcasting entity is left with the choice as to whether or not to apply a standard concerning viewing restriction to its broadcast, and in many cases is performing broadcast without applying such a standard.

Even if a digital broadcast program has viewing restriction information applied thereto, viewing restriction may sometimes fail. For example, if a digital signal of a program is converted to an analog signal before being input to a device, its viewing restriction information will be removed, thus disabling viewing restriction. Moreover, in the case where a receiver, a recorder, and a display device are daisy-chained according to a standard which permits digital transmission, e.g., the IEEE1394 standard, a user is able to view the program without restriction at a display device during recording of the program. The reason is that, according to the IEEE1394 standard, it is impossible to limit outputting to only a specified device among a plurality of daisy-chained devices, and therefore the same signal will be output to all devices. In the case of analog transmission, the recorder may simply mute the video/audio signals against the display device.

Moreover, there have only been insufficient measures for ensuring that, when a program containing viewing restriction information has been recorded, the existence of the program is hidden to any user other than a specified user(s), such that the existence of such a program is not even guessed. For example, a simple measure of not displaying such a program on a listing of already-recorded programs will not suffice. The reason is that a recorder which internalizes a storage medium is complete with a function of displaying a recordable time or vacant capacity of a storage medium. If such values are changed in the absence of a change in the displayed listing, it is easy to guess that there exist an undisplayed program(s), i.e., a program(s) containing viewing restriction information.

### SUMMARY OF THE INVENTION

In order to overcome the problems described above, an objective of the present invention is to provide a technique of adding viewing restriction information at a receiving-end device, even to a broadcast to which a standard concerning viewing restriction is not applied, and controlling outputting of a program based on the viewing restriction information.

Another objective of the present invention is to provide a technique of ensuring that, in connection with recording of a program whose viewing is restricted, the existence of that program is hidden to any user other than a specific user(s), such that the existence of such a program is not even guessed.

A data processing apparatus according to the present invention includes: a reception section for receiving a signal containing video information of a program and guide information, the guide information being utilized for guidance concerning the program and being distinct from viewing restriction information which is defined by a standard; a determination section for determining whether a predetermined pattern for viewing restriction is contained in the guide information or not; a management information generation section for determining whether or not to restrict viewing of the program based on a result of the determination, and generating management information in which presence or absence of viewing restriction is specified with respect to the program; and an output control section for controlling output of information concerning the program based on the management information.

When determining to restrict viewing of the program, the management information generation section may determine one of a plurality of levels concerning stringency of the viewing restriction.

The data processing apparatus may further comprise a recording section for recording the video information and the management information of the program onto a storage medium.

When the management information indicates that viewing of the program is not restricted, the output control section outputs the information concerning the program.

When the management information indicates that viewing of the program is restricted, the output control section prohibits the output of the information concerning the program.

The guide information may contain title information indicating a title of the program, and the determination section may determine whether the pattern is contained in the title information in the guide information or not.

The data processing apparatus may further comprise a manipulation section for outputting a restriction cancel signal for canceling viewing restriction based on a user operation, wherein, when receiving the restriction cancel signal, the output control section lifts prohibition of the output.

The data processing apparatus may further comprise: a management section for keeping under management a remaining capacity value indicating a recordable capacity of the storage medium, the management section retaining a total capacity value of the storage medium and a predetermined capacity value which is smaller than the total capacity value; and a manipulation section for outputting an inquiry signal for inquiring the remaining amount based on a user operation, wherein, when receiving the inquiry signal, the management section may subtract from the predetermined capacity value a total value of the recorded capacity of any program whose viewing is not restricted, and output a result of the subtraction as the remaining capacity value.

Based on a user operation, the manipulation section may further output a restriction cancel signal for canceling viewing restriction, and when receiving the restriction cancel signal, the management section may subtract from the total capacity value a total value of the recorded capacity of all programs that are recorded on the storage medium, and output a result of the subtraction as the remaining capacity value.

The data processing apparatus may further comprise an encryption processing section for, when the viewing of the program is indicated to be restricted in the management information, encrypting the video information and outputting the encrypted video information.

The encryption processing section may comprise: an authentication section for performing an authentication for an external device; an encryption section for encrypting the video information based on an encryption key; and an interface section for transmitting the encrypted video information and the encryption key to any external device that has been authenticated.

The reception section may receive and demodulate at least one of a digital broadcast wave and an analog broadcast wave to acquire the signal.

A method for controlling an output of information concerning viewing restriction according to the present invention includes the steps of: receiving a signal containing video information of a first program; determining whether viewing restriction information of the first program as defined by a standard is contained in the signal or not; receiving a signal containing video information of a second program and guide information, the guide information being utilized for guidance concerning the second program and being distinct from the viewing restriction information defined by the standard; determining whether a predetermined pattern for viewing restriction is contained in the guide information or not; based on results of the determination about the viewing restriction information and about the pattern, controlling output of information concerning the first and second program.

According to the present invention, it is determined whether or not guide information to be utilized for program guidance contains a predetermined pattern for viewing restriction, and it is determined whether or not to restrict viewing based on the result of the determination. Since the guide information is distinct information from the viewing restriction information as defined by a standard, it is possible to set viewing restriction even for a program to which viewing restriction information has not been added at a broadcast station, which is an advantage over any conventional method which controls viewing restriction based only on viewing restriction information.

Furthermore, according to the present invention, management information indicating presence of viewing restriction information as defined by a standard, or management information indicating viewing restriction is generated as management information for a program. Therefore, based on the management information, an indication of any program whose viewing is indicated to be restricted in the viewing restriction information as defined by a standard and an indication of any program whose viewing is restricted based on the guide information can be displayed in a distinguishable manner. Since an indication of any program whose viewing is not restricted can also be displayed in a distinguishable manner, a listing with good browsability can be provided.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a diagram showing the schematic functional block structure of a recorder 100 according to Embodiment 1 of the present invention.

FIG. 2 is a diagram showing the detailed functional block structure of a recorder 210 according to Embodiment 1 of the present invention.

FIG. 3A is a diagram showing an example of a TS packet sequence. FIG. 3B is a diagram showing an example of a partial TS packet sequence.

FIG. 4A is a diagram showing the data structure of an EIT table. FIGS. 4B to 4D are diagrams showing specific examples of an EIT table.

FIG. 5A is a diagram showing the data structure of management information 110b FIGS. 5B to 5D are diagrams showing examples of management information which are generated from the EIT tables shown in FIGS. 4B to 4D, respectively.

FIG. 6 is a flowchart showing the procedure of a recording process by the recorder 210.

FIGS. 7A to 7C are diagrams each showing an exemplary displayed image of a GUI screen generated by a GUI generation section 11.

FIGS. 8A to 8D are diagrams each showing an exemplary displayed image of a listing table concerning programs whose viewing is restricted.

FIG. 9 is a diagram showing the detailed functional block structure of a recorder 220 according to Embodiment 2 of the present invention.

FIG. 10 includes: (a) a diagram showing a HDD 10 having recorded thereon program 1, program 3, and program 4 whose viewing is not restricted as well as program 2 whose viewing is restricted; (b) a diagram showing an order in which programs are played back in accordance with their date/time of recording, in a state where viewing restriction is canceled; and (c) a diagram showing an order in which programs are played back in accordance with their date/time of recording in a default state.

FIG. 11 is a diagram showing the structure of an encryption processing chip 190 according to Embodiment 3 of the present invention.

FIG. 12, which includes (a), (b), and (c), is a diagram showing the relationship between: a recording start time and a recording end time according to which a scheduled recording of program B is performed; and a point in time at which the attribute information of program B is extracted.

FIG. 13 is a diagram showing the detailed functional block structure of a recorder 230 according to Embodiment 4 of the present invention.

FIG. 14 is a diagram showing the specific structure of a GUI generation section 11 according to Embodiment 4.

FIG. 15 is a diagram showing the detailed functional block structure of a recorder 240 according to Embodiment 5 of the present invention.

### DETAILED DESCRIPTION OF PREFERRED EMBODIMENTS

Hereinafter, embodiments of the data processing apparatus according to the present invention will be described with reference to the accompanying drawings.

### Embodiment 1

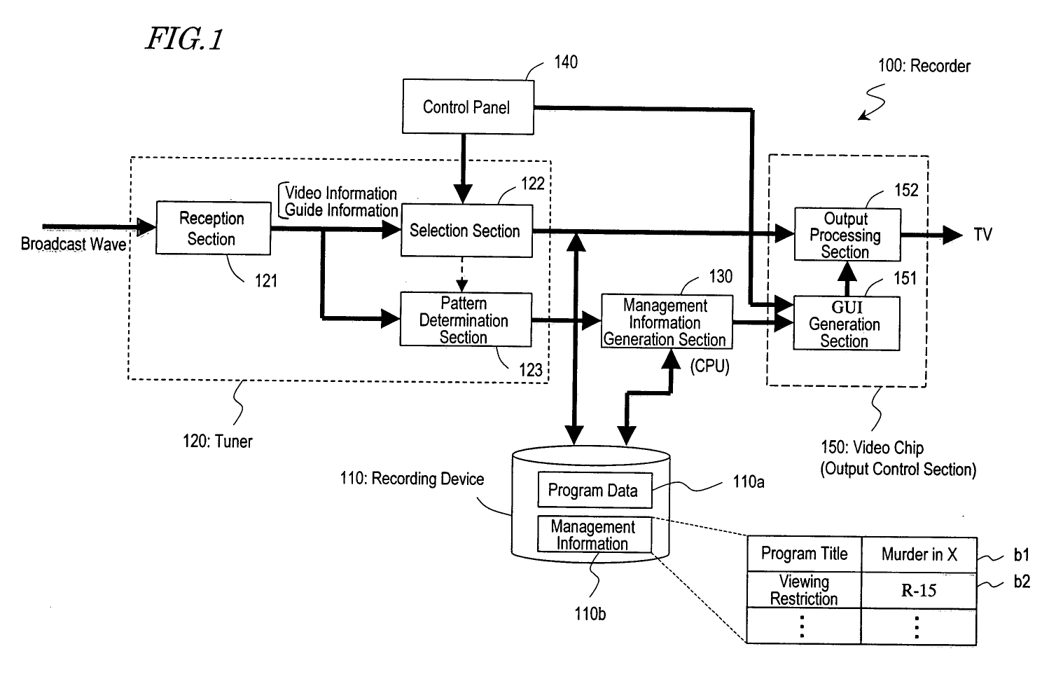

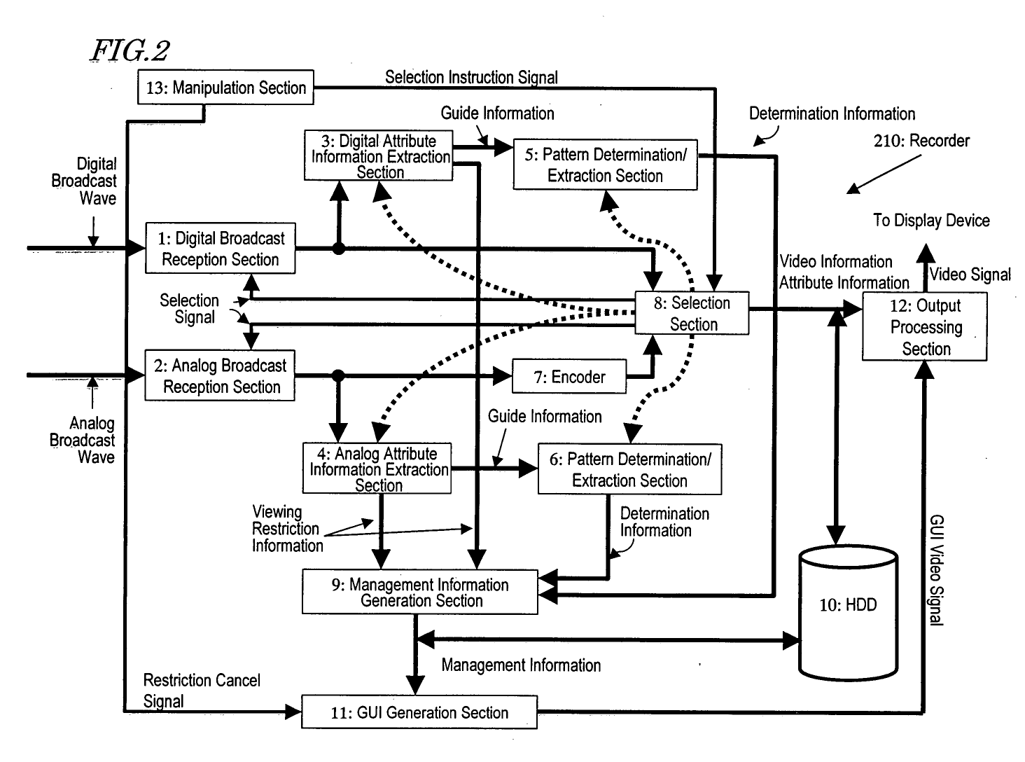

A first embodiment of a data processing apparatus according to the present invention is a recorder which receives a broadcasted program, records the program, and plays back the program. Hereinafter, the main structure of the recorder and its operation will be described with reference to FIG. 1. Thereafter, a more specific structure of the recorder will be described with reference to FIG. 2 and subsequent figures.

FIG. 1 shows the functional block structure of a recorder 100 according to the present embodiment. The recorder 100 comprises a recording device 110, a tuner 120, a management information generation section 130, a control panel 140, and a video chip 150. The recorder 100 generally has a program reception function, a program recording function, and a program playback function. Hereinafter, these functions will be described while also describing the constituent elements which are necessary for each function. A user manipulates the control panel 140 to control the recorder 100, i.e., selects and designates a function to be executed.

First, the program reception function will be described. The tuner 120 includes a reception section 121, a selection section 122, and a pattern determination section 123. The reception section 121 receives a broadcast wave, and the selection section 122 performs a selection based on a selection instruction which is input via the control panel 140, and outputs video information and audio information of a selected program.

The pattern determination section 123 determines whether or not any predetermined pattern which would require viewing restriction is contained in guide information to be utilized for program guidance, and outputs the result of determination. The guide information is distinct from viewing restriction information, and may be a program title, for example. Some broadcasting entities do not apply viewing restriction information standards (described earlier) to their broadcasts, but rather add a text pattern such as “R-15-rated” to each program name. Therefore, presence of any such pattern in the guide information is determined, and the result of the determination is output.

Note that the tuner 120 may have a function of outputting viewing restriction information as stipulated according to a relevant standard. The viewing restriction information is information which is already contained in the received broadcast.

Next, the management information generation section 130 will be described. In practice, the management information generation section 130 may be a CPU of the recorder 100 which executes a computer program, for example. Through information processing based on such a computer program, the management information generation section 130 realizes its functions. Specifically, based on the result of determination by the pattern determination section 123, the management information generation section 130 determines whether viewing of the program in question is to be restricted or not, and generates and outputs management information 110b in which presence or absence of viewing restriction is specified with respect to that program.

Let's say the result of determination indicates that the program name includes “R-15-rated”. Then, the management information generation section 130 generates management information 110b for restricting the viewing of the program which is currently being received. In FIG. 1, the management information 110b is stored in the recording device 110 (described later). Note that, in the case where the management information generation section 130 has received viewing restriction information as stipulated according to a relevant standard, the management information may be generated based also on the viewing restriction information.

Next, the recording function will be described. The recording device 110 receives video information and audio information of the program which has been selected by the tuner 120, and records them onto a storage medium as program data 110a. The recording device 110 also records onto the storage medium the management information 110b which has been generated by the management information generation section 130. The management information 110b contains, for example, a program title b1 and information b2 which indicates whether viewing is to be restricted or not. Without being limited to binary information concerning whether viewing is to be restricted or not, the information b2 may include a level of restriction in the case where viewing is indeed to be restricted, e.g., “R-15” (indicating that viewing would be inappropriate for people under fifteen), and “R” (indicating that viewing would be inappropriate for underage people).

The storage medium may be a magnetic storage medium such as a hard disk or a magnetic tape, an optical storage medium such as a DVD or a Blu-ray disc, a semiconductor storage medium such as an EEPROM, or an magneto-optical disk, for example.

Next, the playback function will be described. In the present specification, “playback” generally refers to outputting, of the video information and audio information of a program stored in the recording device 110. In addition, it is also intended that “playback” encompasses outputting of the video information and audio information of a received program to an output device (e.g., a TV), where recording of the received program does not occur. In the latter playback process, too, management information is generated via the management information generation section 130.

The video chip 150 includes a GUI generation section 151 and an output processing section 152. The GUI generation section 151 receives management information, and, based on the management information, generates a GUI signal for displaying a viewing restriction status of the program. In the case where the information b2 indicates that viewing is to be restricted, for example, a GUI video signal for displaying a listing table of already-recorded programs which excludes any information of the program in question is output.

The output processing section 152 converts a video signal and/or an audio signal of a digital format to signals which are suitable for external outputting. Moreover, the output processing section 152 is able to output the video signal while superposing (overlaying) the GUI video signal from the GUI generation section 151 onto the video signal. As a result, the user can see a listing table of the programs that are stored in the recording device 110. Even during a real-time playback of the program, or during a playback from the recording device 110, the user is able to confirm attribute information such as the program title, for example.

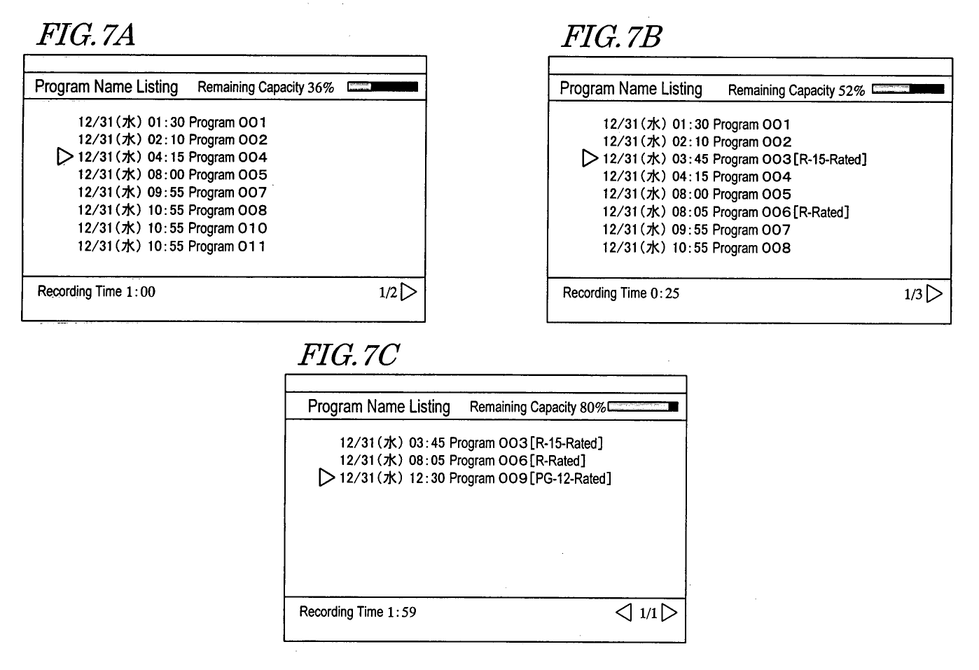

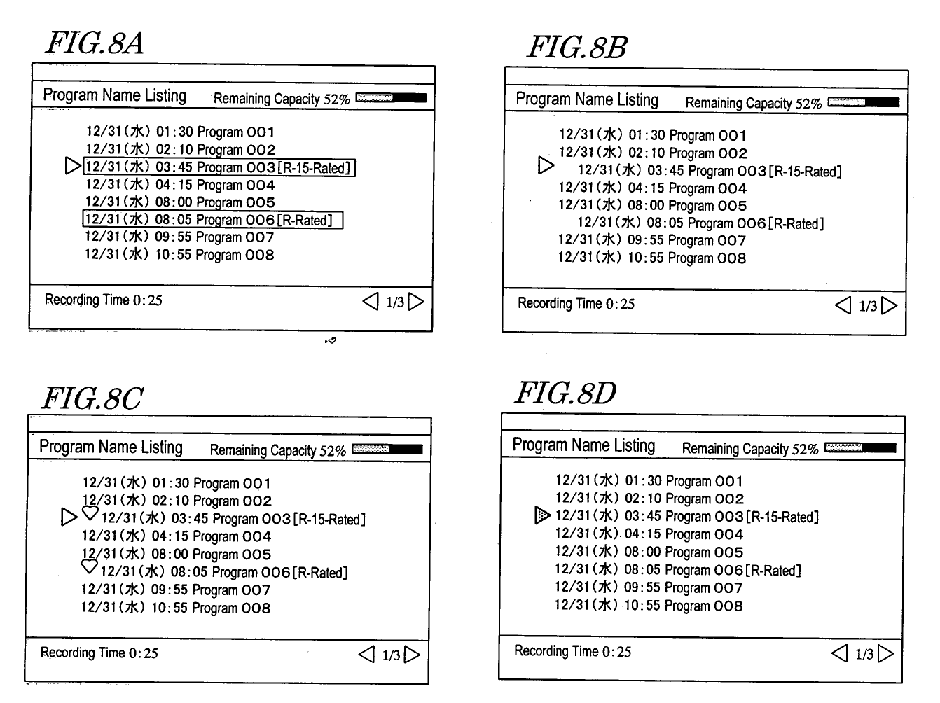

As described above, the video chip 150 controls output of information concerning each program. That is, the video chip 150 functions as an output control section. More specifically, based on the presence or absence of viewing restriction, the video chip 150 permits or prohibits the output of the information concerning the program, or lifts the prohibition. Thus, the information of the program is switched between displayed state or undisplayed state. In addition, when the information is displayed, method of presentation can be changed by the output control section 150 as shown in FIGS. 7A to 7C, 8A to 8D.

Next, with reference to FIG. 2, a more specific structure of the recorder according to the present embodiment will be described. For simplicity, the following descriptions of the present specification will only refer to the processing of video information of a program, and any description of the processing of audio information will be omitted in principle.

FIG. 2 shows the detailed functional block structure of the recorder 210. The recorder 210 is constructed by expanding on the tuner 120 of the recorder 100 shown in FIG. 1, and supports reception, recording, and playback of a digital broadcast and an analog broadcast. The digital broadcast may be a BS or CS digital broadcast, a digital terrestrial broadcast, or a digital-type CATV broadcast, for example. The analog broadcast may be a terrestrial analog broadcast, or an analog-type CATV broadcast, for example.

Specifically, a digital broadcast reception section 1 and an analog broadcast reception section 2 of the recorder 210 correspond to the reception section 121 of the recorder 100′. Pattern determination/extraction sections 5 and 6 of the recorder 210 correspond to the pattern determination section 123 of the recorder 100. A HDD 10 of the recorder 210 corresponds to the recording device 110 of the recorder 100. A manipulation section 13 of the recorder 210 corresponds to the control panel 140 of the recorder 100. A digital attribute information extraction section 3, an analog attribute information extraction section 4, and an encoder 7 of the recorder 210 are additions to the structure of the recorder 100, and the descriptions of these elements will be given later. On the other hand, it is to be understood that those constituent elements of the recorder 210 and the recorder 100 that share identical names are mutual counterparts, having identical functions and structures.

The constituent elements of the recorder 210 will be specifically described. Those constituent elements which are related to digital broadcast will be described first, followed by descriptions of constituent elements that are related to analog broadcast.

The digital broadcast reception section 1 receives and demodulates a digital broadcast wave which is supplied via an external antenna, and outputs a digital video signal. The digital video signal is to be output in a format which is suitable for transmission, e.g., a commonly-employed MPEG transport stream (hereinafter “TS”).

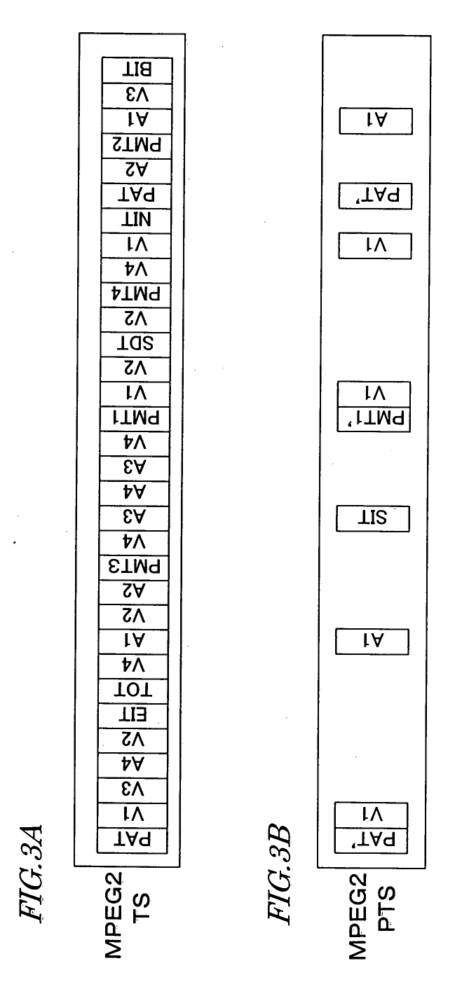

FIG. 3A shows an exemplary TS packet sequence. Each box, in which PAT, V1, etc., is described, corresponds to one TS packet. Notation “Vn” and “An” (where n is 1 to 4) respectively represent that these packets contain video and audio data of program n.

Attribute information concerning a program is multiplexed onto a TS, whereby a wide variety of services are realized. The attribute information includes guide information, viewing restriction information, and copy control information.

In a BS digital broadcast, guide information is defined in the form of short-event descriptors and extended-event descriptors in an EIT table within an EIT packet. Viewing restriction information is also defined as parental rate descriptors in an EIT table. Note that copy control information is defined as a digital copy control descriptor in a table PMT within a PMT packet.

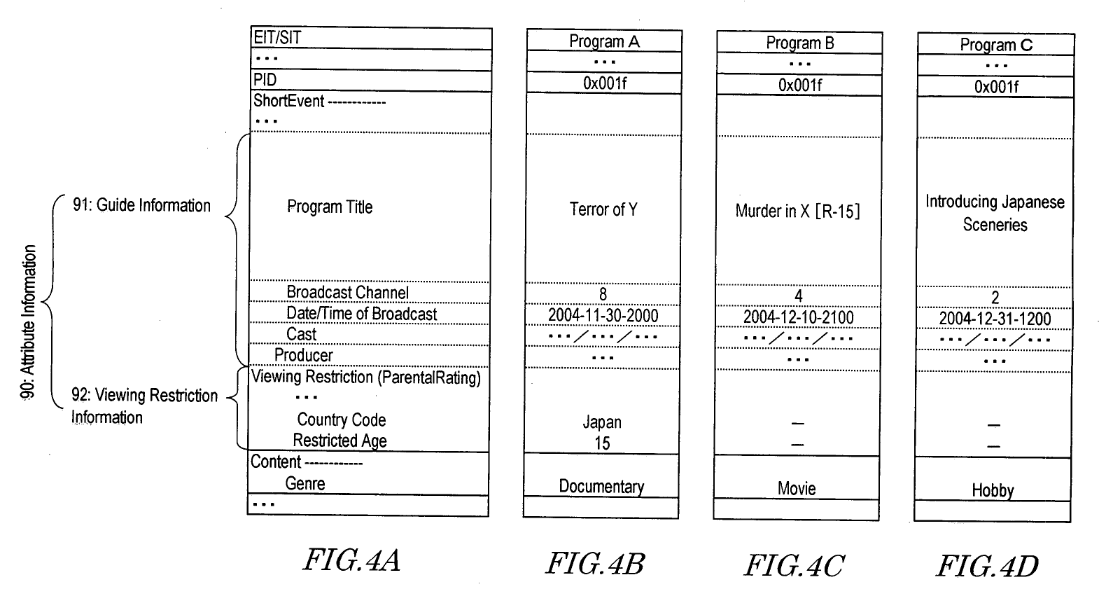

FIG. 4A shows the data structure of an EIT table. The EIT table contains guide information 91 and viewing restriction information 92. The guide information 91 contains information specifying the program title, cast, story, broadcast channel, date/time of broadcast of the program, cast of the program, producer, and the like. The viewing restriction information 92 contains a broadcast country code, and a maximum age value at which viewing of the program is restricted. The guide information 91 and the viewing restriction information 92 compose attribute information 90.

FIG. 4B and FIG. 4C show specific examples of EIT tables of programs whose viewing by people who are fifteen years old or under is restricted. FIG. 4B shows an EIT table which recites viewing restriction information 92. FIG. 4C shows an EIT table which does not recite any viewing restriction information 92. In the example shown in FIG. 4C, a text sequence [R-15], which indicates the presence of a viewing restriction, is contained in the program title “Murder in X [R-15]” in the guide information 91. This is an example where the broadcasting entity prefers to indicate the presence of a viewing restriction without relying on viewing restriction information as stipulated by a relevant standard.

On the other hand, FIG. 4D shows an EIT table of a program for which no viewing restriction exists. Nowhere in the program title of the guide information 91 or the viewing restriction information 92 is contained any information that indicates presence of a viewing restriction.

Referring back to FIG. 2, the digital attribute information extraction section 3 searches through the EIT, PMT, and SIT tables to extract the attribute information 90 which is multiplexed onto the digital video signal. Then, the guide information 91 is extracted from within the attribute information 90, and output to the pattern determination/extraction section 5. In the case where viewing restriction information 92 exists, this information is extracted and output t6 the management information generation section 9 (described later).

The pattern determination/extraction section 5 determines whether a specific pattern is contained in the extracted guide information 91 or not. If any specific pattern is contained, the pattern is extracted and output as a determination result. For example, the pattern determination/extraction section 5 determines whether any text sequence indicative of a viewing restriction program is found at the end of the title, e.g., “[R-15]” or “[PG-12]”. Alternatively, the determination/extraction section 5 determines whether a specific pattern indicative of adult-orientedness (e.g., a specific symbol such as “★”) is found at the beginning of the program title or not. Further alternatively, the determination/extraction section 5 determines whether a predesignated director name (e.g., the name of a director who is known to have directed many adult-oriented movies) is contained in the producer information within the guide information 91. The result of determination is output to the management information generation section 9 as determination information. Note that the pattern determination/extraction section 5 may also output a whole or part of the guide information in addition to the determination information.

Next, constituent elements which are related to analog broadcast will be described.

The analog broadcast reception section 2 receives one of a variety of analog broadcast waves which are supplied via an external antenna, demodulates it, and outputs an analog video signal.

In analog broadcast, too, a standard has been designated that stipulates that guide information, viewing restriction information, and copy control information be multiplexed for output: the EIA-608 standard, which stipulates that attribute information be inserted at the twenty-first scanning line (line #21). To an analog video signal, attribute information such as guide information and viewing restriction information is multiplexed. Moreover, in analog broadcast, program guide information is distributed by utilizing a broadcast wave from a specific key station. The program guide information contains information specifying the program title, broadcast channel, date/time of broadcast of the program, cast of the program, and producer, and thus can be regarded the same as the aforementioned guide information. Note that the program guide information can also be acquired via a communication network such as the Internet.

The analog attribute information extraction section 4 extracts the attribute information which is multiplexed onto the analog video signal 102. For example, the guide information, viewing restriction information, and the like which are inserted at line #21 are extracted in accordance with the EIA-608 standard. The analog attribute information extraction section 4 extracts the guide information from within the attribute information, and outputs it to the pattern determination/extraction section 6. In the case where viewing restriction information exists, this information is extracted and output to the management information generation section 9 (described later).

The pattern determination/extraction section 6 performs substantially the same process as the process performed by the pattern determination/extraction section 5. Since the process does not differ between digital broadcast and analog broadcast, the description of the pattern determination/extraction section 6 is omitted, and the description of the pattern determination/extraction section 5 is relied upon instead.

The encoder 7 encodes the analog video signal 102 to generate a TS. For example, the encoder 7 generates a TS. By generating a TS, it becomes possible to utilize, as the subsequent processing route for the video signal, the same processing route as that for digital broadcast. This makes for a simplified structure.

Next, the selection section 8 will be described. The selection section 8 functions both when receiving a digital broadcast and when receiving an analog broadcast. Based on a selection instruction signal from the manipulation section 13, the selection section 8 outputs a selection signal to the digital broadcast reception section 1 and/or the analog broadcast reception section 2, thus controlling the reception sections 1 and 2. As a result, only a signal on a predetermined channel is received at the reception sections 1 and 2.

In accordance with the selection instruction signal, the selection section 8 receives a digital broadcast TS or a TS which has been generated from an analog broadcast. In the case where the digital broadcast TS contains data of a plurality of programs on a single channel, the selection section 8 extracts data of one of the programs based on the selection instruction signal from the manipulation section 13.

For example, if the selection instruction signal instructs that program 1 should be selected, the selection section 8 generates from the TS as shown in FIG. 3A a partial TS concerning program 1 as shown FIG. 3B. This process is as follows. First, the selection section 8 extracts video and audio packets V1 and A11 corresponding to program 1, and extracts tables PAT and PMT1 of the program-related information, rewrites the contents thereof so as to correspond to the selected program, thus generating “PAT′” and “PMT1′”. Moreover, the service information (SI) and the program specific information (PSI) which are contained in the TS are edited for generating an SIT table which is a collection of information that only concerns the selected program. These packets are positioned in place to generate a partial TS.

Moreover, the selection section 8 controls the digital attribute information extraction section 3, the analog attribute information extraction section 4, the pattern determination/extraction section 5, and the pattern determination/extraction section 6, so as to instruct them to send viewing restriction information and determination information to the management information generation section 9 as necessary.

For example, in the case of digital broadcast, when a broadcast station which is known not to multiplex any viewing restriction information is being selected, the selection section 8 controls the digital attribute information extraction section 3 so as to skip the process of extracting viewing restriction information and perform outputting of guide information with a higher priority.

In the case where the broadcast station utilizes a specific symbol (e.g., “★”) in the program title to indicate that the program is an adult-oriented program, the selection section 8 instructs the pattern determination/extraction section 5 so as to give more priority to a pattern determination directed to that symbol.

The reason why priority levels are introduced to the information to be extracted is as follows. The attribute information contained in an MPEG-TS signal is written in an EIT table and a PMT table, and such information can be retrieved by extracting specific patterns. If there are levels of priority among the kinds of information to be extracted, the digital attribute information extraction section 3 only needs to comprise a single means of pattern search. If there are N kinds of information having the same priority level, the digital attribute information extraction section 3 simply needs to comprise N means of pattern search.

On the other hand, if there aren't levels of priority among the kinds of information to be extracted, it will be necessary for the digital attribute information extraction section 3 to have as many pattern search means as the entire number (M, where M>N) of kinds of information that are expected to be used by other blocks, or efficient operations will not be realized. Therefore, in the present embodiment, the selection section 8 determines the priority levels of the necessary information, thus simplifying the structure implementing the digital attribute information extraction section 3, and reducing cost.

Similarly, as for analog broadcast, if the selected channel is of a broadcast type (or broadcast channel) which is known to provide an EIA-608-compliant signal, priority is given to the process of extracting attribute information from line #21. Conversely, if the selected channel is of a broadcast type (broadcast channel) which is known not to provide information on line #21, priority is given to detection of the attribute information that is distributed on the broadcast wave.

Thus, by controlling the priority levels of information extraction based on the broadcast type or broadcast station as known only to the selection section 8, it becomes possible to efficiently extract information concerning the relevant program.

Next, the management information generation section 9 will be described. Based on the viewing restriction information and the determination information, the management information generation section 9 determines the viewing restriction level of a program to be recorded or a program to be played back, and generates management information concerning viewing restriction. This process is applied to both a digital broadcast program and an analog broadcast program.

For example, assume the case where the received determination information indicates that the program title contains the text sequence “PG” by itself, without being followed by any number, the management information generation section 9 does not apply any viewing restriction, thus leaving the viewability determination open to parental guidance.

On the other hand, if the received determination information indicates that “PG” is followed by a two digit number, e.g., “−13”, it is determined that an age restriction as represented by that number exists, because such an indication is known to generally provide a stronger restriction than the simple indication of “PG” alone. If the text sequence “R-rated” is contained, it is determined that the program is X-rated and that viewing by people who are nineteen years or under must be restricted.

The viewing restriction levels may be fixed to the two simple levels of whether the program is to be restricted or not. For example, it may be decided that viewing is restricted altogether for any program whose program title recites “R-rated” or “R-◯◯-rated” (where ◯◯ is a number representing age). Alternatively, it may be decided that viewing is restricted altogether for any program whose program title recites “PG”, “PG-◯◯”, “R-rated”, or “R-◯◯-rated” (where ◯◯ is a number representing age).

Furthermore, it may be possible to employ an additional rule stipulating that viewing of any program must be restricted whose guide information indicates that a name of an actor or actress who is known to appear frequently in adult-oriented movies is included among the cast names. Furthermore, it may be decided that any program that is broadcasted on a specific broadcast channel (e.g., a toll channel) is to be restricted.

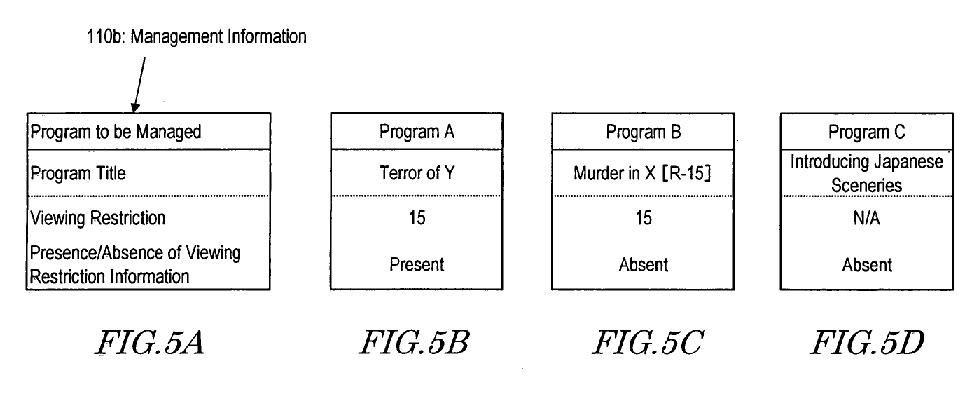

FIG. 5A shows the data structure of the management information 110b. The management information 110b includes information specifying a program to be managed, guide information (such as a program title), information concerning viewing restriction, and a flag indicating presence or absence of viewing restriction information. The information concerning viewing restriction may only describe presence or absence of viewing restriction, and/or only describe a level of viewing restriction. Note that the flag indicating presence or absence of viewing restriction information indicates whether viewing restriction information was contained in the broadcast program as broadcasted. In other words, this flag indicates whether viewing restriction information was always contained in the broadcast or a viewing restriction has been set based on the guide information.

FIGS. 5B to 5D show pieces of management information which are generated from the EIT tables shown in FIGS. 4B to 4D, respectively. From FIG. 5C, it is understood that management information specifying a level of viewing restriction has been set from the EIT table of FIG. 4C, which in itself contains no viewing restriction information.

When recording a program, the management information generation section 9 generates and outputs management information corresponding to the program to be recorded. The management information in this case further contains a TS file name, an address on the HDD 10, and the like of the relevant program. In addition, the management information may contain information concerning the program which is currently being played back or recorded, and/or information concerning programs to be broadcasted in the future. Such management information is to be utilized when the user wishes to confirm the future broadcasting schedule, and its content is to be displayed on the screen.

The HDD 10 is a recording device having a hard disk as a storage medium. It is assumed that the HDD 10 is built in the recorder 210.

Based on whether a restriction cancel signal has been input or not and based on the management information, the GUI generation section 11 generates a signal of an image (GUI) to be displayed. More specifically, the GUI generation section 11 receives the management information of the already-recorded program(s) from the HDD 10, and generates data for displaying a listing of the programs that are recorded on the HDD 10, and outputs the data as a GUI video signal. Moreover, based on the management information concerning the program which is being viewed (or recorded), the GUI generation section 11 generates display data for displaying program information, and outputs a GUI video signal of that data.

With respect to the already-recorded program(s), the program which is being viewed, and/or the program(s) to be broadcasted in the future, the GUI generation section 11 generates a GUI video signal in accordance with the viewing restriction levels defined in the management information. The GUI video signal is to be generated in such a manner that the information (e.g., the title, date/time of broadcast, and channel) of any program whose viewing is restricted is excluded from the listing table and the program guide; that is, the GUI video signal does not indicate existence of any such program. When constructing a program guide directed to the program which is being viewed and/or the program(s) to be broadcasted in the future, the GUI generation section 11 may leave open any portion (display slot) which would otherwise have displayed information of a program whose viewing is restricted, or place a certain symbol in each such slot. On the other hand, if a restriction cancel signal is received, the GUI generation section 11 constructs a listing table and a program guide showing all programs, and outputs a GUI video signal of the same.

The output processing section 12 converts a video signal of the program in a digital format and the GUI video signal into signals which are compatible with an external display device, e.g., analog video signals. For example, the output processing section 152 includes an MPEG decoder, and converts MPEG video/audio streams into analog video signals at the MPEG decoder. Alternatively, the output processing section 152 converts MPEG signals to signals of a format compatible with a digital I/F standard, e.g., the HDMI standard.

The output processing section 12 has a function of superposing the GUI video signal onto the video signal for output. Since this function has been described in connection with the output processing section 152 in FIG. 1, the description thereof is omitted here.

The manipulation section 13 outputs various signals based on the user's operation. The user's operations are to be rendered via buttons provided on the housing of the recorder 210 or via a remote control (not shown). For example, the manipulation section 13 generates a selection instruction signal concerning selection and a restriction cancel signal for canceling viewing restriction, and outputs these signals.

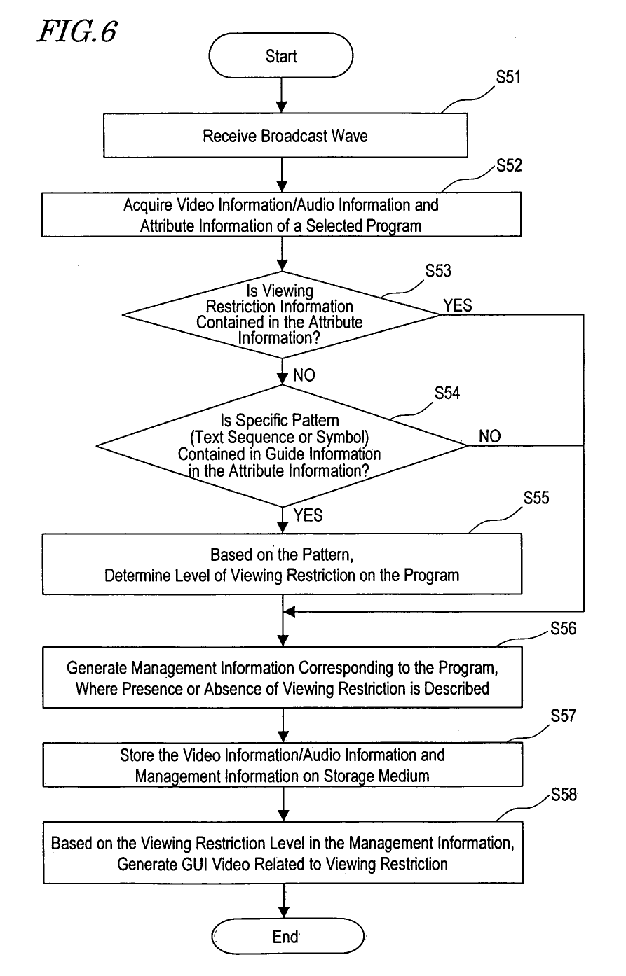

Next, referring to FIG. 6, processes which are performed in the recorder 210 will be described. Although the following descriptions assume that a digital broadcast program is recorded, it will be appreciated that the processes will be similar for recording of an analog broadcast program as well.

FIG. 6 shows the procedure of a recording process by the recorder 210. At step S51, the digital broadcast reception section 1 receives a broadcast wave of a digital broadcast program to be recorded. The broadcast wave to be received is determined based on a selection signal from the selection section 8. At step S52, the digital broadcast reception section 1 demodulates the broadcast wave to acquire the video information/audio information and attribute information of the selected program, and output such information.

At step S53, the digital attribute information extraction section 3 determines whether viewing restriction information is contained in the attribute information or not. If viewing restriction information is contained, the process proceeds to step S56; otherwise, the process proceeds to step S54. At this time, the digital attribute information extraction section 3 outputs guide information to the pattern determination/extraction section 5.

The branching process of step S53 stands on the premise that, if viewing restriction information is contained, such information shall be treated with a higher priority, thus making it possible to omit steps S54 and S55. However, even in the case where viewing restriction information is contained, the process from S54 and subsequent steps may be performed in order to allocate an appropriate viewing restriction level based on the guide information.

At step S54, the pattern determination/extraction section 5 determines whether the guide information contains a specific pattern (a text sequence or symbol) or not. If such a specific pattern is contained, the process proceeds to step S55; otherwise, the process proceeds to step S56. The pattern determination/extraction section 5 sends the result of determination to the management information generation section 9 as determination information. The determination information contains information of the specified pattern.

At step S55, based on the determination information, the management information generation section 9 determines the level of viewing restriction on the program, according to what the specified pattern is. For example, if the program title includes the text sequence “R-15”, it is determined that the viewing restriction level (age) is directed to people under fifteen, i.e., viewing of the program is not appropriate for people under fifteen.

At the next step S56, the management information generation section 9 generates management information corresponding to the program, where presence or absence of viewing restriction is described. If a viewing restriction level is also available at this time, the level may also be described. Note that presence of viewing restriction may simply be indicated by describing a viewing restriction level alone. Note that, although no explicit description is required to indicate absence of viewing restriction, it would also be possible to describe absence of viewing restriction in the form of explicit information.

At step S57, the HDD 10 records the video information/audio information and management information onto the storage medium.

Then, at step S58, based on the viewing restriction level in the management information, GUI video related to the viewing restriction imposed on the program is generated. This enables the user to confirm on the display device the information concerning the viewing restriction which ist imposed on the program being recorded. By writing the GUI video information which has been generated through the process of step S58 to an internal memory (not shown) or the HDD 10, it will become unnecessary to later generate GUI video, thus reducing the amount of time until GUI video is displayed. However, the process of step S58 is not an essential part of the recording process; instead, GUI video may be generated after recording upon need.

Through the aforementioned process, it is possible to not only determine necessity of viewing restriction on the program, but also set an appropriate level of viewing restriction, even in the case where no viewing restriction information is contained in the stream of the received program.

Now, referring to FIGS. 7A to 7C and FIGS. 8A to 8D, exemplary displayed images of listings of programs that are recorded on the HDD 10 will be described. In the following descriptions, it is assumed that the recorder 210 is set in a mode such that programs whose viewing is restricted are not displayed on the program listing immediately after power activation. When the recorder 210 displays a listing of already-recorded programs, the GUI generation section 11 operates as follows.

Based on the content defined in the “viewing restriction” section of the management information 110b of the HDD 10, the GUI generation section 11 constructs a listing table directed only to the programs whose viewing is not restricted, and outputs a GUI video signal of the same. The information of any program whose viewing is restricted is excluded from the listing table. FIG. 7A shows an exemplary displayed image of a program guide directed only to the programs whose viewing is not restricted.

Thereafter, if the user performs an operation to cancel viewing restriction and the manipulation section 13 detects this operation, the manipulation section 13 outputs a viewing restriction cancel signal. The GUI generation section 11 receives the viewing restriction cancel signal, reconstructs a program guide which additionally contains information of programs whose viewing is restricted, and outputs a GUI video signal of the same. FIG. 7B shows an exemplary displayed image of a program guide which encompasses all of the already-recorded programs. As compared to the displayed image shown in FIG. 7A, it will be understood that “program 003[R-15-rated]” and “program 006[R-rated]”, whose viewing is restricted, are added to the displayed image of FIG. 7B. Thus, the user is allowed to see a program guide containing programs whose viewing is restricted.

Note that the GUI generation section 11 may also construct a listing consisting only of programs whose viewing is restricted. FIG. 7C shows an exemplary displayed image of a listing consisting only of programs whose viewing is restricted. To obtain such a listing, the GUI generation section 11 may search through the management information to check whether any information concerning viewing restriction is described, and generate a listing of programs corresponding to any pieces of management information in which such information is described. Note that a program (“program 009 [PG-12-rated]”) appears in the exemplary displayed image of FIG. 7C, which did not exist in FIG. 7B. Since the programs whose viewing is not restricted are omitted from the program listing, this program has been moved up from the page where it was originally to be displayed, i.e., the next page (“page 2/3”) to the page shown in FIG. 7B (“page 1/3”).

On the program listing, the programs whose viewing is restricted can be distinguished by various methods. Hereinafter, when referring to a program listing, any program whose viewing is restricted will simply be referred to as a “restricted program”, and any program whose viewing is not restricted will simply be referred to as a “non-restricted program”.

For example, FIG. 8A shows an exemplary image in which each restricted program is enclosed in a frame. Instead of using a frame, the background color of each restricted program may be varied from the background color of the non-restricted programs. FIG. 8B shows an exemplary image in which the restricted programs are displayed in staggered positions relative to the non-restricted programs. FIG. 8C shows an exemplary image in which each restricted programs is distinguished by a specific mark. FIG. 8D shows an exemplary image in which the color of the cursor is changed when the cursor is pointing to a restricted program.

Without being limited to the exemplary images illustrated above, text sequences of different sizes or different fonts may be used to distinguish restricted programs from non-restricted programs. Alternatively, the restricted programs may be displayed separately from the non-restricted programs.

Furthermore, the displaying method may be more finely differentiated among the restricted programs themselves. For example, those programs whose viewing is restricted based on the viewing restriction information in the attribute information as acquired at the time of broadcasting may be distinguished from those program whose viewing is restricted through the operations of the pattern determination/extraction section and the management information generation section according to the present embodiment. To realize this, the GUI generation section 11 may refer to the management information 110b (FIG. 5A), and, among the programs whose viewing is restricted, introduce differences as to the color or position with which each program is displayed, the mark to be assigned to each program, etc., based on whether the flag indicating presence or absence of viewing restriction information reads “present” or “absent”. By concurrently displaying the non-restricted programs in a distinguishable manner, visual recognition is improved so that the user can easily understand the status of each program.

Immediately after power activation, the recorder 210 may be set in a mode such that any and all programs will appear on the program listing. Then, when the user gives an instruction to not display the restricted programs, the non-restricted programs alone may be left displayed.

Furthermore, a method may be adopted in which viewing restriction is classified into a plurality of different levels and managed so that only a specific level of viewing restriction becomes cancelable, or a method may be adopted in which all levels below (or above) a specific level are simultaneously cancelable. In such cases, as the user subsequently makes level changes, it becomes possible to prioritize contents whose restriction is allowed to be cancelled.

One variant which may be adopted in connection with the user's operation for canceling viewing restriction is as follows: the manipulation section 13 outputs a restriction cancel signal only after the recorder 210 authenticates that the user has an authority to cancel. The method of authentication may be, for example, password-based authentication, authentication utilizing the user's biometric information, or authentication based on information which is stored in an externally-connected nonvolatile storage medium, e.g., signature or public key information. Furthermore, when canceling restriction, a fee may be paid to the program which becomes viewable.

When the management information indicates that the program which is being recorded to the HDD 10 is a subject of viewing restriction, the output processing section 12 may mute the video signal output. This makes it possible to prevent the program which is being recorded from being viewed by a third party.

In the present embodiment, it is assumed that the digital broadcast reception section 1 receives a BS/CS broadcast or a digital terrestrial broadcast. However, there is no limitation as to the type of digital broadcast so long as attribute information is multiplexed onto video/audio signals for output.

Moreover, the pattern determination processes to be performed by the pattern determination/extraction sections 5 and 6 and the parameters used for such determination may be stored in a nonvolatile memory or the HDD 10, such that the pattern determination/extraction sections 5 and 6 is allowed to refer to them when necessary. By updating such processes and parameters from outside of the recorder 210, it will be possible to support changes in the operation plans of each broadcast station or changes in the broadcasting standard. Note that an external update can be made by: reading information from a removable medium, e.g., a nonvolatile storage medium or a magneto-optical disk; acquiring from the broadcast wave the information which is inserted in the broadcast wave; or downloading via the Internet or other networks using various communication means.

The digital video signal may be input to the recorder 210 via a network. For example, a network connection interface which is compliant with the DLNA standard may be provided, and copyright-protected programs may be allowed to be viewed, recorded, or delivered via network lines. Moreover, a digital video signal which is provided through a video-on-demand (VOD) service utilizing a network may be input to the recorder 210. In either case, the processing by the recorder 210 according to the present embodiment is applicable because attribute information is transmitted in a multiplexed form.

Furthermore, FIG. 2 illustrates a case where a digital broadcast wave and an analog broadcast wave are separately supplied from the outside, so as to be respectively input to the digital broadcast reception section 1 and the analog broadcast reception section 2. However, both broadcast waves may be supplied in an intermixed state from the outside. In this case, however, the recorder 210 would need to have a splitter for splitting the input signal so as to be supplied to the digital broadcast reception section 1 and the analog broadcast reception section 2.

### Embodiment 2

A second embodiment of the data processing apparatus according to the present invention is a recorder which receives, records, and plays back a broadcasted program. The recorder of the present embodiment further includes a program management section in addition to the recorder structure of Embodiment 1. The program management section has a function of keeping the recording areas of the HDD 10 under management such that the existence of any programs whose viewing is restricted will not be guessed by a user, especially a person of low age who is restrained from viewing certain programs.

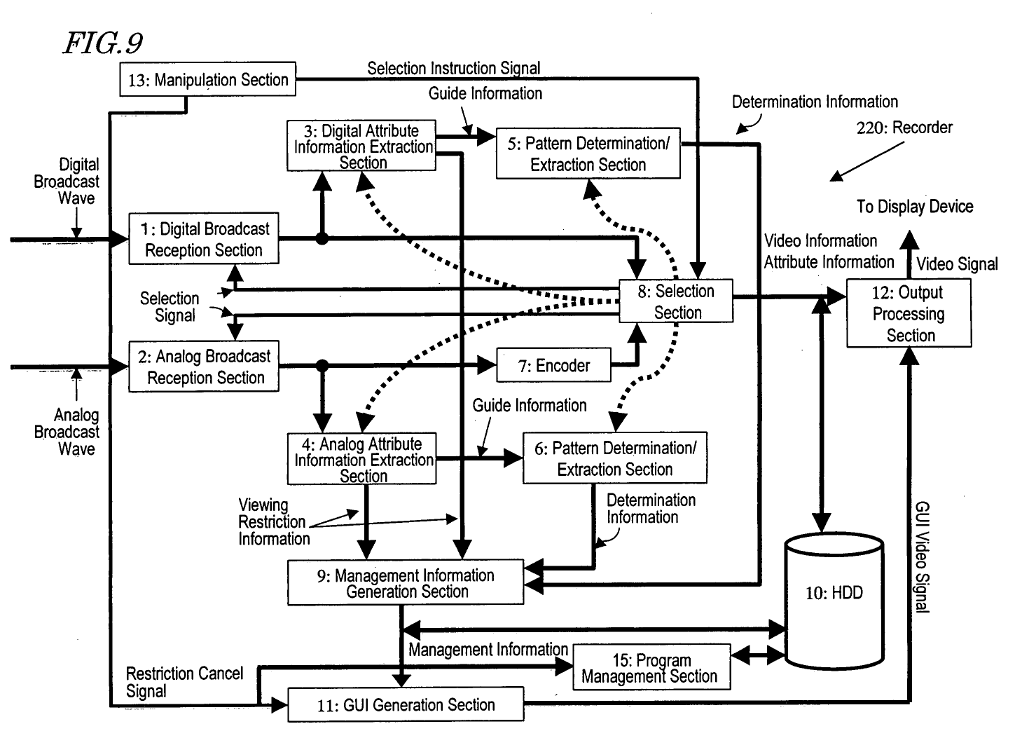

FIG. 9 shows a detailed functional block structure of the recorder 220 of the present embodiment. The recorder 220 includes a program management section 15 in addition to the recorder 210 of FIG. 2. The functions and operations of the constituent elements of the recorder 220 other than the program management section 15 are basically the same as those of the recorder 210 (FIG. 2). Therefore, the function and operation of the program management section 15 as well as the operations of other constituent elements related to such operation will be described below.

In practice, the program management section 15 may be a CPU of the recorder 220 which executes a computer program, for example. Through information processing based on such a computer program, the program management section 15 realizes its functions.

Firstly, the general function of the program management section 15 is as follows. Based on the particulars of the viewing restriction described in the management information, the program management section 15 classifies each program which is being or has been recorded into one or more groups. Then, the amount of used data in the HDD 10 is kept under management on a group-by-group basis. Furthermore, when consecutively playing back recorded programs, the program management section 15 controls the HDD 10 so as to read video information and management information of the programs on a group-by-group basis.

Hereinafter, a management function of the program management section 15 will be specifically described, followed by a description of a read control function. In the following descriptions, it is assumed that video information and management information of a plurality of programs are recorded on the HDD 10.

The program management section 15 classifies each program which is recorded on the HDD 10 and the currently-recorded program into one or more groups, based on the presence or absence of viewing restriction and/or viewing restriction level in the management information. Then, a maximum recordable capacity is defined for each group.

For example, the program management section 15 classifies programs into: a group of programs whose management information recites viewing restriction; and a group of programs whose management information does not recite viewing restriction, and sets a maximum capacity for each group. Then, the program management section 15 performs remaining amount management based on the total used capacity and maximum capacity of each program group.

Assuming that the HDD 10 has a total capacity A, the program management section 15 sets a capacity B which is available for the recording of the group of programs whose viewing is not restricted, and a capacity C which is available for the recording of the group of programs whose viewing is restricted, where capacity A=capacity B+capacity C.

Consider a case where the user makes an inquiry about the recordable time (or recordable capacity) via the manipulation section 13. In a normal state (default state), upon receiving an inquiry signal from the manipulation section 13, the program management section 15 calculates and returns the value of:

capacity B—(total capacity of programs which are already recorded and whose viewing is not restricted).

On the other hand, in a state where viewing restriction has been canceled by the user's operation, upon receiving an inquiry signal from the manipulation section 13, the program management section 15 returns the value of: capacity A—(total capacity of all programs).

Furthermore, when the total capacity used by the group of programs whose viewing is not restricted has reached the capacity B as a result of gradual storing of programs, the program management section 15 instructs the HDD 10 to delete the oldest program among the programs whose viewing is not restricted, thus allowing for continued recording. Similarly, when the total capacity used by the group of programs whose viewing is restricted has reached the capacity C, the program management section 15 instructs the HDD 10 to delete the oldest program among the programs whose viewing is restricted, thus allowing for continued recording. The values of the capacity B and capacity C can be changed later. The order of deletion instructions may be different from the playback order. As has been described with respect to the recorder 210 of Embodiment 1, none of the programs whose viewing is restricted is displayed in any listing, etc., on the recorder 220.

Thus, even when a recording of a program whose viewing is restricted is performed, the total number of programs whose viewing is not restricted is not affected, and the vacant capacity does not decrease.

According to the above-described process, even when a recording or erase of a program whose viewing is restricted is performed, the recordable remaining capacity of for the group of programs whose viewing is not restricted is not affected. Therefore, a user who is not granted the authority to cancel viewing restriction cannot guess the existence of any programs which are kept undisplayed due to viewing restriction.

Next, a read control (on the HDD 10) function of the program management section 15 will be described.

Physically, the video information and management information of the respective programs may not necessarily be placed on the HDD 10 in the same order in which the programs were recorded. One reason is that the HDD 10 tries to record information by finding vacant areas that may be located in discrete positions. Another reason is that, when a program is deleted after recording and a defragmentation process is executed for relieving area fragmentations, the physical positions of video information and management information may be changed.

However, in a usual recording/playback device, when displaying a listing of recorded programs on the storage medium, it is often the case that the programs are displayed according to a certain order, e.g., order of recording or order of titles. The program management section 15 displays program contents according to a specific order, and manages the playback order when consecutively playing back the programs.

For example, if the user gives an instruction to play back programs in the order of date/time of recording, the program management section 15 causes the video information (of the group of programs whose viewing is not restricted) to be output from the HDD 10 in the order of date/time of recording, based on the date/time of broadcast information in the attribute information of each program, or the date/time of recording information which is adopted in the file system of the HDD 101.

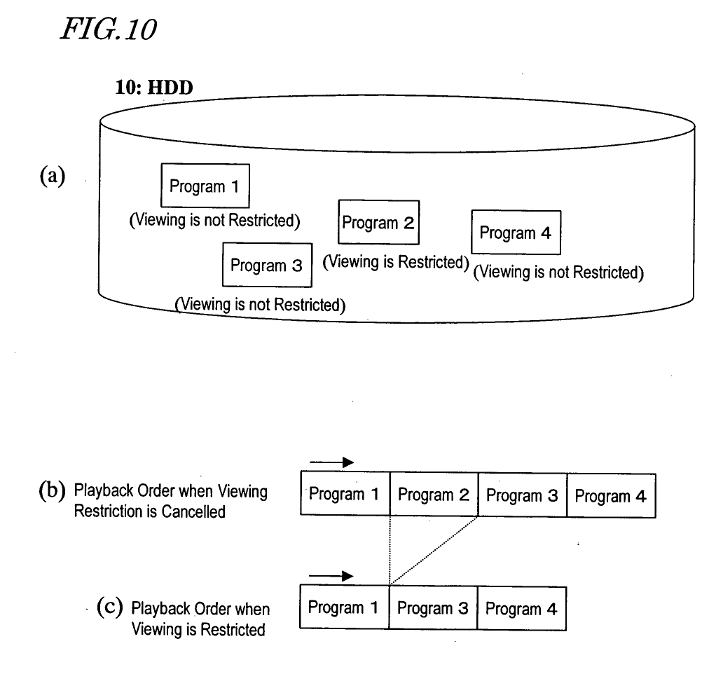

A specific example will be described with reference to (a) to (c) of FIG. 10. It is also assumed in the following description that the program management section 15 manages programs while classifying each program into either the group of programs whose viewing is not restricted and the group of programs whose viewing is restricted.

In (a) of FIG. 10 is shown an HDD 10 in which program 1, program 3, and program 4 (whose viewing is not restricted) as well as program 2 (whose viewing is restricted) are recorded. It is assumed that the order of date/time of recording is programs 1, 2, 3, to 4, from the older to the newer. Although FIG. 10 conveniently describes presence or absence of viewing restriction below each “program”, in actuality, presence or absence of viewing restriction is to be described in the management information corresponding to each program.

When the user makes an inquiry for information concerning already-recorded programs in a default state, the program management section 15 instructs the HDD 10 to output the management information concerning programs 1, 3, and 4. Moreover, when an instruction for consecutively playing back already-recorded programs is given, the program management section 15 instructs the HDD 10 to output video information in the order of programs 1, 3, and 4. In (c) of FIG. 10 is shown the order of programs which are played back in accordance with their date/time of recording in a default state.

Next, in a state where viewing restriction has been canceled by the user's operation, if the user makes an inquiry for information concerning already-recorded programs, the management information concerning programs 1, 2, 3, and 4 is output. If an instruction to consecutively play back programs is given in the state where viewing restriction is canceled, the HDD 10 is similarly instructed to output video information in the order of programs 1, 2, 3, and 4. In (b) of FIG. 10 is shown the order of programs which are played back in accordance with their date/time of recording in the state where viewing restriction is canceled.

Although the above example illustrates a case where programs are played back in the order they were recorded, playback may be managed so that the programs are played back in the reversed order. Moreover, playback management may be performed based not only on time information, but also on the ascending or descending order of program titles, or the length (recording time) of each recorded program.

Note that classification of program groups may be made based not only on presence or absence of viewing restriction, but also on the level of viewing restriction. In that case, the user gives to the recorder 220 a cancel instruction which is in accordance with the level of viewing restriction. For example, the user may give to the recorder 220 a cancel instruction such as: viewing restrictions down to fifteen years old are cancelled; only R-rated viewing restrictions are cancelled; or only PG-rated viewing restrictions are cancelled.

Upon receiving such an instruction, the program management section 15 instructs the HDD 10 to output management information or output video information, and further performs capacity management by setting a maximum recordable capacity for each level.

Note that, since the maximum capacity is only to be compared against a total capacity of programs classified into each level, the maximum capacity value for each level can be changed through later adjustments. Therefore, it is possible to realize a more flexible capacity management than in the case of a commonly-available HDD having a plurality of predefined partitions (management areas).

### Embodiment 3

The present embodiment illustrates an encryption processing chip which is applicable to the recorder of each of Embodiments 1 and 2. The encryption processing chip of the present embodiment applies a predetermined encryption process to a digital video signal which is output from the output processing section 12 of the recorder. As a result, even if the digital video signal is digitally output to a digitally-connected external device at a subsequent stage, it is ensured that appropriate restrictions are imposed on viewing and/or recording on such an external device.

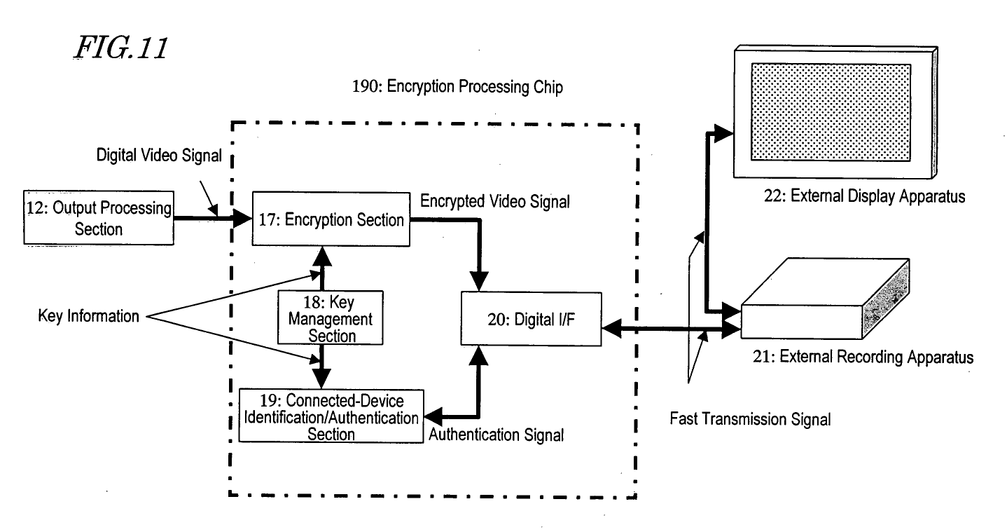

Hereinafter, with reference to FIG. 11, the structure and process of the encryption processing chip will be described.

FIG. 11 shows the structure of an encryption processing chip 190. The encryption processing chip 190 comprises an encryption section 17, a key management section 18, a connected-device identification/authentication section 19, and a digital I/F 20. The encryption processing chip 190 is to be incorporated in the recorder of Embodiment 1 or 2, for example.

The encryption processing chip 190 is connected to an external recording apparatus 21, which serves as a recording device. The external recording apparatus 21 is further connected to an external display apparatus 22, which serves as a display device. The connection between the recorder incorporating the encryption processing chip 190, the external recording apparatus 21, and the external display apparatus 22 is commonly referred to as a daisy-chain connection.

From the output processing section 12, the encryption processing chip 190 receives a digital video signal which is being recorded or played back, or a digital video signal which contains a GUI video signal overlaid on a video signal. This digital video signal is in TS format, for example. Furthermore, the encryption processing chip 190 also receives management information corresponding to the video information, which is also output from the output processing section 12.

If any restriction on the viewing of the video information is stated in the management information, the encryption section 17 encrypts the digital video signal by using an encryption key. The key management section 18 supplies the encryption key to the encryption section 17 and the connected-device identification/authentication section 19, and keeps the encryption key under its management. The key management section 18 will change the key in the case where the connected device has been changed, or the attribute (restrict level) of the digital video signal has been changed, and so on.

The connected-device identification/authentication section 19 is provided for checking the authenticity of a device which transmits an encrypted video signal. The connected-device identification/authentication section 19 determines a unique identification signal of each of the external devices 21 and 22 which are connected to the digital I/F 20, and carries out an authentication protocol. Then, according to the authentication protocol, the connected-device identification/authentication section 19 exchanges authentication signals with the external recording apparatus 21 and the external display apparatus 22. At this time, it is possible to selectively use authentication for recording or authentication for displaying. Thus, it is possible to check whether each device deserves a key which is necessary for decoding an encrypted video signal or not.

The digital I/F 20 converts an encrypted video signal and an authentication signal to a signal format which is suitable for communication with external devices. The digital I/F 20 exchanges a fast transmission signal of about 400 Mbps with the external device 21. The digital I/F 20 performs signal exchanges conforming to the IEEE1394 standard, for example.

Hereinafter, the processes performed by the encryption processing chip 190 will be described. It is assumed that, upon connection of the digital I/F 20 to the external recording apparatus 21, an authentication protocol was performed so that an authentication for recording is already completed with respect to the external recording apparatus 21.

First, the encryption section 17 receives management information and video information from the output processing section 12, and determines whether any viewing restriction is stated in the management information or not. If restriction is stated, the encryption section 17 encrypts the video signal by using the encryption key received from the key management section 18, and outputs the resultant encrypted video signal. Then, only to the external recording apparatus 21 on which recording is authorized, the connected-device identification/authentication section 19 outputs key information for decoding. In the case where viewing restriction is not stated, the video signal may be output from the digital I/F 20 without being subjected to an encryption process.

The digital I/F 20, converts the encrypted video signal and authentication signal to a signal format which is suitable for transmission to externally-connected devices, and outputs them as fast transmission signals.

The external recording apparatus 21 and the external display apparatus 22 are complete with a digital I/F capable of receiving fast transmission signals and a decoding section which performs a decoding process. However, the decryption key for decoding can only be received by those external recording apparatuses 21 which are determined by the connected-device identification/authentication section 19 to be devices on which recording is authorized. Any external recording apparatus 21 that has received a decryption key is able to decode the encrypted video signal in its decoding section, and thus obtains a digital video signal.

For example, the external recording apparatus 21, once learning from the authentication signal that it has been authenticated, enters a waiting state for receiving key information, in accordance with the protocol. When the key information is received, the external recording apparatus 21 decodes the subsequently-received encrypted video signal to obtain a digital video signal. The external recording apparatus 21 sequentially records the obtained digital video signal to the storage medium as video information.

In the case where the encryption processing chip 190 is implemented based on the IEEE1394 standard, the DTCP standard can be utilized as a protocol of authentication with a counterparting device. At this time, determination of the counterparting device may utilize unique ID information which is assigned to each device, or unique information which is contained in the signature data that is used for authentication. By using either information, it becomes possible to limit the devices on which recording is authorized. Especially in the case where unique information contained in the signature data is used, it is possible to prevent unauthorized viewing even more effectively by introducing a tamperproof technique to the signature data itself.

In accordance with the encryption processing chip 190, even if video information of a program whose viewing is restricted is digitally output, it can be ensured that recording of the video signal in a state which permits concurrent playback is allowed only on a specific external recording apparatus(es) which has been authenticated. On the other hand, viewing on any unauthenticated external display apparatus can be prohibited. On any unauthenticated external recording apparatus, recording in a state which permits concurrent playback is prohibited.

Although an IEEE1394 digital I/F has been exemplified, with the DTCP standard being used in the authentication section, a transmission system utilizing Ethernet (registered trademark) can also be constructed. In this case, the DTCP-IP standard can be used for an authentication method.

### Embodiment 4

A fourth embodiment of the data processing apparatus according to the present invention is a recorder which receives, records, and play backs a digital video signal which has been selected by an externally-connected digital broadcast receiver. As compared to the recorders of Embodiments 1 and 2, the recorder of the present embodiment differs in that it does not perform a selection function by itself, and is similar in that the recorder generates management information concerning whether or not to restrict viewing by utilizing attribute information.

The recorder of the present embodiment is especially useful in the case where a scheduled recording is performed. A scheduled recording, as commonly practiced, is begun slightly before a designated recording start time (e.g., about 10 seconds to 1 minute before the start of broadcasting) so that the beginning of the program will be recorded without fail. Therefore, if management information is generated by acquiring attribute information immediately after starting a recording, the presence or absence of viewing restriction for the previous program will be set in the management information, which is inappropriate. Accordingly, in the present embodiment, attribute information is extracted after the lapse of a predetermined time since the start of a recording (e.g., 2 minutes later).

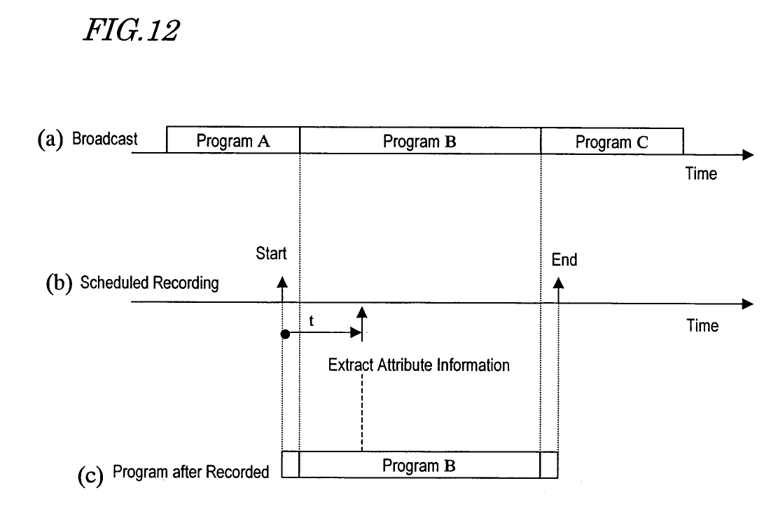

Referring to (a) to (c) of FIG. 12, the operation of the recorder of the present embodiment will be generally described. In (a) of FIG. 12 is shown programs A, B, and C, which are to be broadcasted in this order. When a scheduled recording is performed for program B, the actual recording start time will be a predetermined time before the broadcast start time of program B, and the end of recording will come a predetermined time after program B is ended. In (b) of FIG. 12 is shown the start and end timing of the scheduled recording of program B.

The extraction of attribute information is not begun simultaneously with the start of recording. Rather, extraction is begun after the lapse of a predetermined time since the start of recording. In (c) of FIG. 12 is shown a manner in which attribute information is extracted after the lapse of a time t since the start of recording. The time t may be one minute, and more preferably two minutes. As a result, the viewing restriction information and guide information pertaining to the program for which the scheduled recording is performed are acquired.

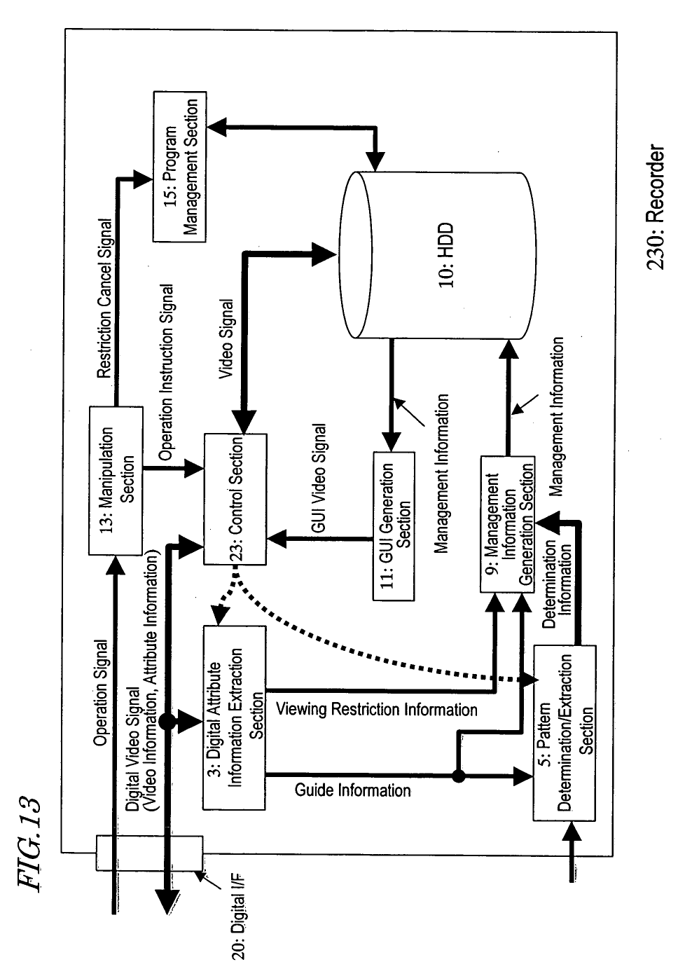

Hereinafter, with reference to FIG. 13, the recorder of the present embodiment will be described.

FIG. 13 shows a detailed functional block structure of the recorder 230 of the present embodiment. Many of the constituent elements of the recorder 230 have their counterparts in the recorder 220 of Embodiment 2. In FIG. 13, any constituent element having an identical function to a that of a constituent element in FIG. 9 is denoted by a like name and reference numeral, and the description thereof is omitted. For any new constituent element, its process will be described.

The recorder 230 comprises a digital I/F 20 and a control section 23. The digital I/F 20, which may for example be a fast serial interface according to the IEEE1394 standard, is provided in order to allow an externally-connected digital broadcast receiver (a so-called digital tuner; not shown) and a display device to be connected to the recorder 230.

When recording, the digital I/F 20 receives a digital video signal from the digital broadcast tuner. This digital video signal contains video information and attribute information. Moreover, when playing: back a program which has been recorded on the HDD 10, the digital I/F 20 outputs to the display device a signal containing the video information and attribute information thereof.

As in the cases of Embodiments 1 and 2, the digital video signal which is input to the digital I/F 20 contains attribute information of each program within tables such as EIT, PMT, and SIT. In a situation where the tuner and the recorder are provided as separate devices, it is likely that the attribute information is contained in the PMT and the SIT because a digital video signal which is output from the tuner is often a partial TS (FIG. 3B) which does not contain an EIT.

Furthermore, the digital I/F 20 receives an operation signal. In the case where the digital I/F 20 is compliant with the IEEE1394 standard, the operation signal is an AVC command set which is transferred asynchronously. In this case, the digital video signal is an MPEG signal which is transferred synchronously.

Note that the AVC command set is a system of commands which is prepared for each category of devices to be operated. By utilizing the AVC command set, a digital broadcast tuner which is connected to the recorder 230 can control the recording/playback operation of the recorder 230.

The control section 23 receives from the manipulation section 13 an operation instruction signal concerning the user's desired operation, and, based on the operation instruction signal, performs necessary control for the recording and playback of a program. During recording, the control section 23 sends a video signal to the HDD 10, and instructs the HDD 10 to perform recording of video information. During playback, the control section 23 receives a video signal which has been read from the HDD 10. Moreover, the control section 23 receives a GUI video signal which is output from the GUI generation section 11, and outputs it as a digital video signal.

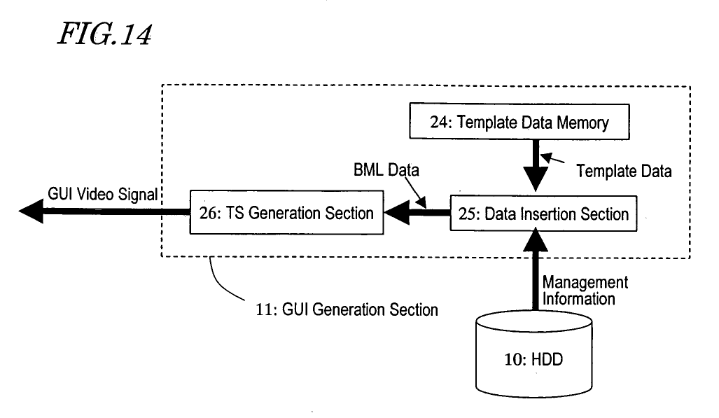

Now, with reference to FIG. 14, an exemplary structure of the GUI generation section 11 will be described. FIG. 14 shows a detailed structure of the GUI generation section 11. This structure is suitable in the case where the digital video signal is of a TS format.

In a digital broadcast environment where the video information of a program is transmitted in a TS format, by default, a receiver has a function of describing a broadcast screen by using a language called BML (Broadcast Markup Language), and outputting it as a data broadcast signal. The GUI generation section 11 is the structure for realizing this function.

The GUI generation section 11 includes a template data memory 24, a data insertion section 25, and a TS generation section 26. The template data memory 24 stores template data, which is data of a boilerplate template for the data broadcast screen which is to be described in BML.

The data insertion section 25 reads the template data from the template data memory 24, and receives the management information of the program which is played back from the HDD 10. Then, the data insertion section 25 inserts the management information into the template data, describes the screen (with the management information inserted therein) in BML, and outputs the screen data. The TS generation section 26 splits the BML data into data units (packets) of the MPEG-TS format, and sends out the data units as a GUI video signal.

Referring back to FIG. 13, the digital attribute information extraction section 3 of the recorder 230 acquires attribute information, after the lapse of a predetermined time t since the start of a recording. In connection with the execution of a scheduled recording, the time t may be prescribed to be about one time to two times as large as the difference between the scheduled point in time and the point in time at which recording is actually begun. For example, in the case where the recorder 230 starts recording one minute before the scheduled point in time, the time t is about 1 to 2 minutes. The time t may be predesignated at shipment of the recorder 230.

The above-described operation of the digital attribute information extraction section 3 is suitable in the recorder 230 of the present embodiment, to which a tuner is externally-connected. The reasons are as follows.

As in the recorders of Embodiments 1 and 2, if a digital broadcast wave tuner and a recording device are accommodated within a single housing, it is possible to receive from the tuner a notification of an actual start of broadcasting of a scheduled program, and control the timing of starting the operation of the digital attribute information extraction section 3. However, in the case where a tuner is externally-connected as in the recorder 230 of the present embodiment, it is not guaranteed that the program start timing can be accurately received. This makes it necessary to start a scheduled recording at an earlier point in time than the scheduled point in time. By allowing the digital attribute information extraction section 3 to operate with the aforementioned timing, it becomes possible to precisely acquire the attribute information of a program for which the user has designated a scheduled recording.

Next, the operation of the recorder 230 will be described. As a particularly suitable usage, a scheduled recording operation will be illustrated. In the following, only the differences from the operation of the recorder 210 of Embodiment 1 will be described, while omitting the descriptions of any similar aspects of operation. The aforementioned variants of the recorder 210 of Embodiment 1 will not be mentioned again here since such variants are similarly applicable to the recorders 230 of the present embodiment.

At the digital I/F 20, the recorder 230 externally receives an operation signal from the user and a digital video signal.

The manipulation section 13 analyzes the operation signal to generate an operation instruction signal, which is then output to the control section 23. The control section 23 receives this operation instruction signal, and controls the respective constituent elements so as to realize the operation as instructed.

When the operation instruction signal designates a recording operation, the control section 23 sends a digital video signal to the HDD 10, and instructs the HDD 10 perform recording. In practice, a continuously incoming video signal is stored to a temporary storage medium (not shown; e.g., a buffer memory) as video information, and recorded to the HDD 10 in data units of a certain data size. At the same time, the management information generation section 9 generates management information and outputs it to the HDD 10.

In the case where the HDD 10 is compliant with the ATA/ATAPI standard, the video information is recorded onto the HDD 10 in data units which are integer multiples of 512 bytes (1 sector). The same is also true in the case where a recording-type optical disk is used instead of the HDD 10. In the case where a semiconductor memory is used instead of the HDD 10, the video information is recorded in bytes, or in a data size which is an integer multiple of a page or sector that is specific to the semiconductor memory used.

Furthermore, as in the selection section 8 of Embodiments 1 and 2, the control section 23 functions so as to efficiently extract information which is required by the management information generation section 9. Specifically, the control section 23 instructs the digital attribute information extraction section 3 and the pattern determination/extraction section 5 of the types of process to be executed and their priority levels.

On the other hand, when the operation instruction signal designates a playback operation, the control section 23 instructs the HDD 10 to read video information. Then, the control section 23 outputs the video information as a digital video signal. The digital video signal is output to a device which is externally-connected via the digital I/F 20, e.g., a display device. Moreover, the control section 23 instructs the HDD 10 to read the management information and output it to the GUI generation section 11.

The GUI generation section 11 receives the management information from the HDD 10, and generates data for displaying a listing of programs that are recorded on the HDD 10, and outputs the data as a GUI video signal. Specifically, based on the management information, the GUI generation section 11 generates a listing which does not include the program names of programs whose viewing is restricted, and outputs a GUI video signal of the same.

The control section 23 outputs the received GUI video signal itself as a digital video signal. This digital video signal is externally output from the recorder 230 via the digital I/F 20. A digital device which has received this signal analyzes its content by regarding the signal as a data broadcast, and presents an image based on this signal to a user. Note that the control section 23 does not need to separately output a GUI video signal and a video signal of the program content. For example, the control section 23 may generate a digital video signal by multiplexing the GUI video signal onto the video signal, and output the result. In this case, the user is able to view the video on a data broadcast screen in which the video appears to be embedded.

In another exemplary structure of the GUI generation section 11, an image generation section which generates image data of a displayed image based on management information and an encoder which encodes the data into MPEG format may be comprised.

Note that the GUI generation section 11 is able to generate a listing of programs whose viewing is not restricted based on the listing management information, or generate a listing of any and all programs when a restriction cancel signal is received. The restriction cancel signal is issued from the manipulation section 13 to the program management section 15 when the manipulation section 13 has received a special command. This special command for designating cancellation of viewing restriction can be predesignated in the AVC command set.

Furthermore, means for performing external communications by using electrical signals, radiowaves, magnetism, light, invisible rays, or the like (e.g., infrared reception or serial transfer means) may be added to the manipulation section 13. Then, via a communication device such as a remote control, a mobile communication device, or a computer, the recorder 230 may directly receive an instruction from the user. The instruction from the user may contain information which is directly given to the pattern determination/extraction section 5 to be utilized as a criterion of pattern determination by the pattern determination/extraction section 5. For example, in the case where it is desired to impose viewing restrictions on viewers who are fifteen years old or under, the user directly instructs from the manipulation section 13 to the pattern determination/extraction section 5 that a “program viewing restriction” be imposed on “fifteen years old or under”. Based on this instruction, the pattern determination/extraction section 5 sets the pattern determination criterion to [R-15].

Moreover, the digital I/F 20 may be furnished with an encryption/decoding function as well as an encryption key management section, and digital video signals may be received or transmitted in an encrypted form. In this case, the recorder 230 of the present embodiment can serve as the external recording apparatus in Embodiment 3.

Moreover, a network may be utilized as a transmission medium of digital video signals. In this case, the digital I/F 20 may use an I/F which is compatible with Ethernet (registered trademark).

### Embodiment 5

A fifth embodiment of the data processing apparatus according to the present invention is a recorder which receives an analog video signal and attribute information separately from an externally-connected digital broadcast receiver, and records a program. As compared to the recorders of Embodiments 1 and 2, the recorder of the present embodiment differs in that it does not perform a selection function by itself, and is similar in that the recorder generates management information concerning whether or not to restrict viewing by utilizing attribute information.

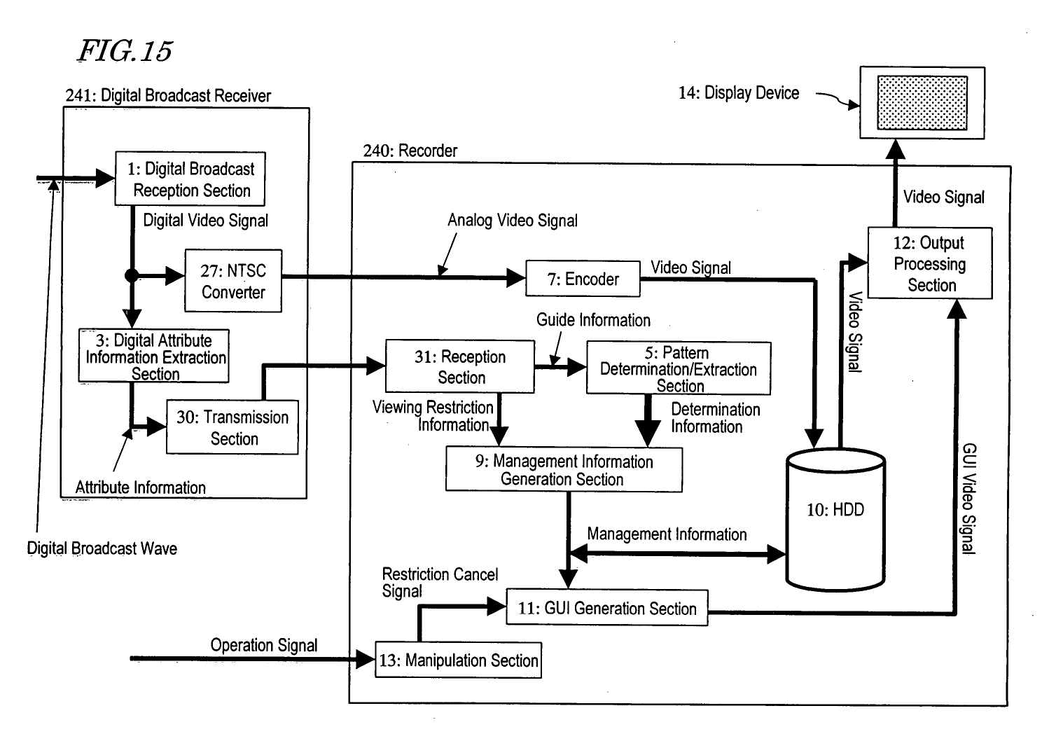

FIG. 15 is a detailed functional block structure of a recorder 240 of the present embodiment. The recorder 240 is connected to a digital broadcast receiver 241, and also to a display device 14. The recorder 240 and the digital broadcast receiver 241 constitute a recording system, and the recorder 240 and the display device 14 constitute a playback system.

Many of the constituent elements of the recorder 240 and the digital broadcast receiver 241 have their corresponding counterparts in the recorder 210 of Embodiment 1 and the recorder 220 of Embodiment 2. In FIG. 15, constituent elements having such corresponding functions are denoted by the same names and reference numerals as those used in FIG. 2, and the descriptions thereof are omitted. As for those constituent elements which perform different processes, such processes will be described.

The digital broadcast receiver 241 receives a digital broadcast wave, and outputs an analog video signal and attribute information. The digital broadcast receiver 241 is to be realized in the form of a settop box or a tuner for digital broadcast.

The digital broadcast receiver 241 comprises a digital broadcast reception section 1, a digital attribute information extraction section 3, an NTSC converter 27, and a transmission section 30. The NTSC converter 27 breaks up the video contained in a digital video signal into RGB signal components for each image (frame), thereafter generates a standardized NTSC signal, and outputs this analog video signal. The transmission section 30 transmission signal outputs the attribute information to the outside of the digital broadcast receiver 241. For example, the transmission section 30 converts the attribute information into an electrical signal in a serial transmission format, or a transmission signal such as an infrared signal.

Note that the digital broadcast reception section 1 may have some of the functions of the selection section 8 shown in FIG. 2. For example, the digital broadcast reception section 1 may receive from the user an operation signal specifying a channel which is to be viewed or recorded, and extract a digital video signal exclusively on the channel specified by the operation signal. Furthermore, in the case where a plurality of programs are being broadcasted on a specified channel, data concerning one of the programs is taken out, and output as a partial TS.

The recorder 240 includes a reception section 31 for receiving attribute information. The reception section 31 determines whether viewing restriction information is contained in the received attribute information or not, and if any viewing restriction information is contained, reception section 31 sends the viewing restriction information to a management information generation section 9. Moreover, the reception section 31 sends the guide information in the attribute information to a pattern determination/extraction section 5.

An encoder 7 in the recorder 240 receives an analog video signal and generates a TS, which is sent to the HDD 10. The HDD 10 stores this TS as program data. Note that it is possible to play back a digital broadcast in real time by using the digital broadcast receiver 241, the recorder 240, and the display device 14. In this case, the encoder 7 may directly output the generated TS to the output processing section 12.

Next, the operation of the recorder 240 when recording a program will be described.

The digital broadcast reception section 1 of the digital broadcast receiver 241 receives a digital broadcast wave from an external device such as an antenna, and outputs a digital video signal of a program. The NTSC converter 27 converts the digital video signal into an NTSC signal of analog format, and outputs this signal. At the same time, the digital attribute information extraction section 3 extracts the attribute information. The transmission section 30 outputs the attribute information to the recorder 240.

As described above, the digital broadcast receiver 241 transmits the analog video information and the attribute information to the recorder 240 while always keeping the two kinds of information in association with each other.

Next, the encoder 7 of the recorder 240 receives the analog video signal and converts it to a digital video signal. Moreover, the reception section 31 extracts viewing restriction information and/or guide information from the attribute information, and outputs the information to the management information generation section 9 and/or pattern determination/extraction section 5. The subsequent processes to be performed by the pattern determination/extraction section 5, the management information generation section 9, the HDD 10, and the GUI generation section 11 are identical to the processes which are performed by the namesake constituent elements of the recorder 210 of Embodiment 1. Based on the viewing restriction information and/or guide information, the management information generation section 9 sets the presence or absence, and/or level of viewing restriction for that program, and is able to appropriately restrict viewing based on such settings.

As is clear from the above description, even after a digital broadcast program has been converted into analog video, it is possible to set the presence or absence and/or level of viewing restriction since the recorder receives the attribute information of that program. Based on such settings, the recorder is able to prohibit playback of any program whose viewing is restricted, and, from among all programs that are recorded on the HDD 10, generate a listing of programs from which inappropriate programs are excluded.

In the above-described embodiments, the management information has data structure as shown in FIG. 5A. However, other data structure may be adopted. For example, predetermined pattern(s) for viewing restriction contained in the guide information may be described directly in the field of “Viewing Restriction” shown in FIG. 5A. Further, information on recording date and time of programs may be described with or in lieu of program titles, and only recording date and time may be displayed in examples shown in FIGS. 7A to 7C and FIGS. 8A to 8D.

In the above-described embodiments, it is intended that “viewing” encompasses not only watching the video of a program but also listening to the audio of the program. Moreover, a broadcast may be performed not only via radiowaves, but also via a data communication network.

In each of the above embodiments, the management information generation section is illustrated as the recorder's CPU that executes a computer program. However, instead of a general-purpose CPU, the management information generation section may be implemented as a semiconductor integrated circuit designed for specific purposes (Application Specific Integrated Circuit; ASIC). Such a circuit may further combine the functions of the pattern determination section 123 shown in FIG. 1 and the pattern determination/extraction section(s) shown in FIG. 2. In particular, by adding the above-described functions of the pattern determination/extraction section and the management information generation section to a so-called V-chip which is now a mandatory element in any broadcast receiver available in the U.S., it becomes possible to set more certain and appropriate viewing restrictions.

A data processing apparatus according to the present invention is able to, even with respect to a broadcast program which does not contain viewing restriction information as stipulated by a relevant standard, specify presence or absence of viewing restriction by utilizing concurrently-acquired guide information, and control the outputting of a program based on such settings.

While the present invention has been described with respect to preferred embodiments thereof, it will be apparent to those skilled in the art that the disclosed invention may be modified in numerous ways and may assume many embodiments other than those specifically described above. Accordingly, it is intended by the appended claims to cover all modifications of the invention that fall within the true spirit and scope of the invention.

This application is based on Japanese Patent Applications No. 2004-345359 filed on Nov. 30, 2004 and No. 2005-341458 filed on Nov. 28, 2005, the entire contents of which are hereby incorporated by reference.

What is claimed is:

1. A data processing apparatus comprising:
a reception section for receiving a signal containing video information of a program and guide information, the guide information being utilized for guidance concerning the program and being distinct from viewing restriction information which is defined by a standard;
a determination section for determining whether a predetermined pattern for viewing restriction is contained in the guide information or not;
a management information generation section for determining whether or not to restrict viewing of the program based on a result of the determination, and generating management information in which presence or absence of viewing restriction is specified with respect to the program; and
an output control section for controlling output of information concerning the program based on the management information.

2. The data processing apparatus of claim 1, wherein, when determining to restrict viewing of the program, the management information generation section determines one of a plurality of levels concerning stringency of the viewing restriction.

3. The data processing apparatus of claim 1, further comprising a recording section for recording the video information and the management information of the program onto a storage medium.

4. The data processing apparatus of claim 1, wherein,
when the management information indicates that viewing of the program is not restricted,
the output control section outputs the information concerning the program.

5. The data processing apparatus of claim 1, wherein,
when the management information indicates that viewing of the program is restricted,
the output control section prohibits the output of the information concerning the program.

6. The data processing apparatus of claim 1, wherein,
the guide information contains title information indicating a title of the program; and
the determination section determines whether the pattern is contained in the title information in the guide information or not.

7. The data processing apparatus of claim 5, further comprising a manipulation section for outputting a restriction cancel signal for canceling viewing restriction based on a user operation, wherein,
when receiving the restriction cancel signal, the output control section lifts prohibition of the output.

8. The data processing apparatus of claim 3, further comprising:
a management section for keeping under management a remaining capacity value indicating a recordable capacity of the storage medium, the management section retaining a total capacity value of the storage medium and a predetermined capacity value which is smaller than the total capacity value; and
a manipulation section for outputting an inquiry signal for inquiring the remaining amount based on a user operation, wherein,
when receiving the inquiry signal, the management section subtracts from the predetermined capacity value a total value of the recorded capacity of any program whose viewing is not restricted, and outputs a result of the subtraction as the remaining capacity value.

9. The data processing apparatus of claim 8, wherein,
based on a user operation, the manipulation section further outputs a restriction cancel signal for canceling viewing restriction; and
when receiving the restriction cancel signal, the management section subtracts from the total capacity value a total value of the recorded capacity of all programs that are recorded on the storage medium, and outputs a result of the subtraction as the remaining capacity value.

10. The data processing apparatus of claim 1, further comprising an encryption processing section for, when the viewing of the program is indicated to be restricted in the management information, encrypting the video information and outputting the encrypted video information.

11. The data processing apparatus of claim 10, wherein the encryption processing section comprises:
an authentication section for performing an authentication for an external device;
an encryption section for encrypting the video information based on an encryption key; and
an interface section for transmitting the encrypted video information and the encryption key to the external device that has been authenticated.

12. The data processing apparatus of claim 1, wherein the reception section receives and demodulates at least one of a digital broadcast wave and an analog broadcast wave to acquire the signal.

13. The data processing apparatus of claim 1, wherein the output control section changes method of presentation of the information concerning the program based on the presence or absence of viewing restriction.

14. A method for controlling an output of information concerning viewing restriction, comprising the steps of:
receiving a signal containing video information of a first program;
determining whether viewing restriction information of the first program as defined by a standard is contained in the signal or not;
receiving a signal containing video information of a second program and guide information, the guide information being utilized for guidance concerning the second program and being distinct from the viewing restriction information defined by the standard;
determining whether a predetermined pattern for viewing restriction is contained in the guide information or not;
based on results of the determination about the viewing restriction information and about the pattern, controlling output of information concerning the first and second program.
